(19) United States
(12) Patent Application Publication
(10) Pub. No.: US 2012/0121308 A1
(43) Pub. Date: May 17, 2012

(54) PRINTER CUTTER AND METHOD FOR CONTROLLING PRINTER CUTTER

(75) Inventors: Takashi HIGUCHI, Tomi-city (JP); Tadanori IPPONYARI, Tomi-city (JP)

(73) Assignee: MIMAKI ENGINEERING CO., LTD., Tomi-city (JP)

(21) Appl. No.: 13/357,615

(22) Filed: Jan. 25, 2012

Related U.S. Application Data
(63) Continuation of application No. PCT/JP2009/063363, filed on Jul. 27, 2009.

(51) Int. Cl. B41J 11/66

(52) U.S. Cl. 400/621

(57) ABSTRACT

A printer cutter includes a head device, a cutter device, a cutting controller, and a print controller. The head device is to print an image on a medium. The head device is relatively movable with respect to the medium. The cutter device is to cut the medium. The cutter device is relatively movable with respect to the medium. The cutting controller is configured to cut a printing region of the medium on which the image is to be printed by using the cutter device before the image is printed in the printing region. The print controller is configured to print the image in the printing region by using the head device after the printing region has been cut by the cutting controller.

### CROSS-REFERENCE TO RELATED APPLICATIONS

The present application is a continuation application of International Application No. PCT/JP2009/063363, filed Jul. 27, 2009. The contents of this application are incorporated herein by reference in their entirety.

### BACKGROUND OF THE INVENTION

1. Field of the Invention

The present invention relates to a printer cutter and a method for controlling a printer cutter.

2. Discussion of the Background

A printer cutter has been commonly known which is provided with a head unit from which ink droplets are ejected to a medium to perform printing and a cutter unit for performing cutting of the medium. In the printer cutter, first, an origin mark and an image are printed on a medium by using the head unit and, after that, an origin for cutting the medium is determined on the basis of the origin mark printed on the medium and cutting of the medium is performed by using the cutter unit (see, for example, Japanese Patent Laid-Open No. 2005-335147).

### SUMMARY OF THE INVENTION

According to one aspect of the present invention, a printer cutter includes a head device, a cutter device, a cutting controller, and a print controller. The head device is to print an image on a medium. The head device is relatively movable with respect to the medium. The cutter device is to cut the medium. The cutter device is relatively movable with respect to the medium. The cutting controller is configured to cut a printing region of the medium on which the image is to be printed by using the cutter device before the image is printed in the printing region. The print controller is configured to print the image in the printing region by using the head device after the printing region has been cut by the cutting controller.

According to another aspect of the present invention, a method for controlling a printer cutter includes cutting a printing region of a medium on which an image is to be printed using a cutter device of the printer cutter before the image is printed in the printing region, and printing the image in the printing region using a head device of the printer cutter after the printing region has been cut.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an enlarged view showing a part of a printer cutter in accordance with an embodiment of the present embodiment.

FIGS. 2A and 2B are explanatory views showing a structure of a medium. FIG. 2A is a cross-sectional view showing the medium and FIG. 2B is a front view showing the medium.

FIG. 3 is a view showing a structure of a drive mechanism.

FIG. 4 is a diagram showing an example of a functional structure of a control section.

FIG. 5 is a view showing a lowered position of a cutter holder when a medium is to be cut.

FIGS. 6A and 6B are views for explaining correction of a cut line.

FIGS. 7A and 7B are views for explaining correction of a cut line.

FIG. 8 is a flow chart showing a processing operation of a printer cutter.

FIG. 9 is a flow chart showing a correcting value calculation processing shown in FIG. 8.

FIG. 10 is a flow chart showing a cut-and-print processing shown in FIG. 8.

FIG. 11 is a view for explaining calculation of a feed correcting value.

FIGS. 12A through 12E are schematic views showing an operation of a printer cutter.

### DESCRIPTION OF THE EMBODIMENTS

The embodiments will now be described with reference to the accompanying drawings, wherein like reference numerals designate corresponding or identical elements throughout the various drawings. However, the present invention is not limited to the embodiment described below. In all drawings, the same reference signs are used in the same or corresponding portions.

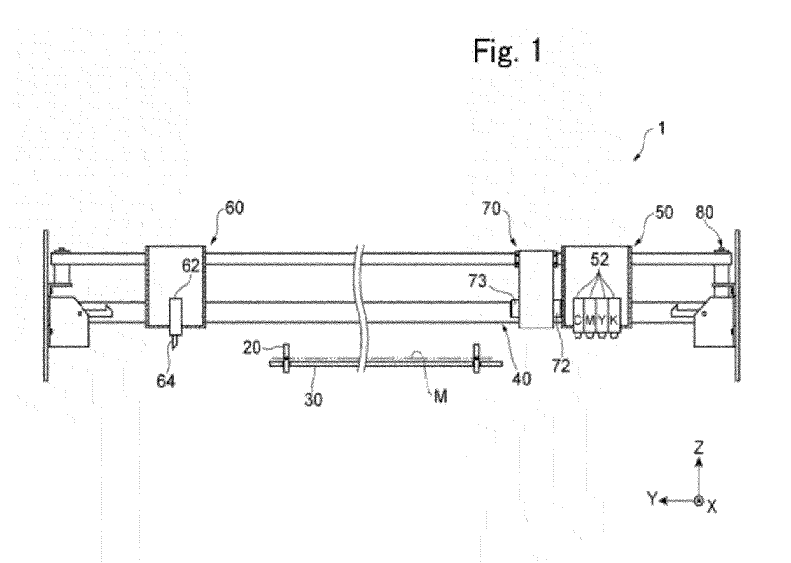

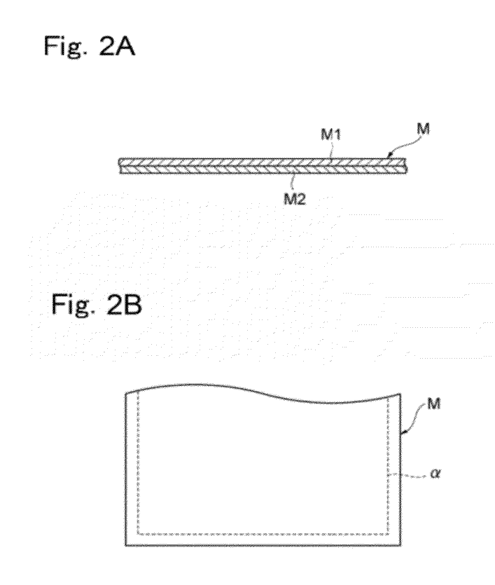

FIG. 1 is an enlarged view showing a part of a printer cutter in accordance with an embodiment of the present embodiment. FIGS. 2A and 2B are explanatory views showing a structure of a medium. FIG. 2A is a cross-sectional view showing the medium and FIG. 2B is a front view showing the medium. As shown in FIG. 1, a printer cutter 1 in accordance with an embodiment of the present invention is an apparatus in which a medium “M” is fed on a platen 30 by feed rollers 20, an image is printed on the medium “M” on the basis of printing data and cutting data transmitted from a personal computer or the like, a cut-out work for cutting the medium “M” is performed, and the like. As shown in FIG. 2A, a medium “M” is formed in a two-layer structure comprised of a sticker “M1” having adhesiveness and a mount “M2” to which an adhesive face of the sticker “M1” is adhered. The printer cutter 1 prints an image on the basis of printing data in a printing region “a” of the sticker “M1” and cuts the sticker “M1” along a cut line on the basis of cutting data to perform a cut-out work on the sticker “M1” on which the image is printed.

As shown in FIG. 1, in the printer cutter 1, a guide rail 40 is fixed above the platen 30 for supporting a medium “M” so as to extend along an extending direction of the platen 30. A head unit 50, a cutter unit 60 and a connection unit 70 are supported by the guide rail 40 so as to be capable of sliding. Further, the printer cutter 1 is provided with a drive mechanism 80 for moving the connection unit 70. In the following descriptions, a separating direction (upper direction in FIG. 1) in directions where the platen 30 is moved close to and separated from the guide rail 40 is referred to as a “Z”-axis direction, a left direction (left direction in FIG. 1) in directions where the guide rail 40 is extended in right and left directions is referred to as a “Y”-axis direction (scanning direction), and a feeding direction (front direction in FIG. 1) of a medium “M” is referred to as an “X”-axis direction.

The feed roller 20 feeds a medium “M” in the “X”-axis direction or in an opposite direction to the “X”-axis direction. Therefore, when a feeding amount of the medium “M” by the feed rollers 20 is adjusted, the position in the “X”-axis direction of the medium “M” with respect to the head unit 50 and the cutter unit 60 is adjusted.

The head unit 50 ejects ink droplets of “C” (Cyan), “M” (Magenta), “Y” (Yellow) and “K” (Black) to print an image on the medium “M”. The head unit 50 is movably attached to the guide rail 40. The head unit 50 is mounted with four inkjet head modules 52 corresponding to respective colors of “C”, “M”, “Y” and “K”. A plurality of nozzles for ejecting ink droplets of each of the colors toward the platen 30 is provided on an under face of each of the inkjet head modules 52. Therefore, when ink droplets are ejected from the respective inkjet head modules 52 while the head unit 50 is moved along the guide rail 40 in the “Y”-axis direction, an image is printed in a printing region “a” of a medium “M”. In this embodiment, a right end part of the guide rail 40 (right end part in FIG. 1) is determined as a standby position of the head unit 50.

The cutter unit 60 cuts a medium “M” to perform a cut-out work and the like. The cutter unit 60 is movably attached to the guide rail 40. A cutter holder 62 which holds a cutter member 64 for cutting a medium “M” is mounted in the cutter unit 60. The cutter unit 60 holds the cutter holder 62 so as to be capable of vertically moving in the “Z”-axis direction and, in addition, capable of turning around the “Z”-axis direction. Therefore, the medium “M” can be cut by vertically moving the cutter holder 62 in the “Z”-axis direction and by turning the cutter holder 62 around the “Z”-axis when the cutter unit 60 is moved in the “Y”-axis direction and the medium “M” is moved in the “X”-axis direction. In this embodiment, a left end part (left end part in FIG. 1) of the guide rail 40 is determined as a standby position of the cutter unit 60.

The connection unit 70 is disposed between the head unit 50 and the cutter unit 60 and is to be connected with either or both of the head unit 50 and the cutter unit 60. The connection unit 70 is movably attached to the guide rail 40 and is connected with the drive mechanism 80. A first connecting part 72 for being connected with the head unit 50 is provided on a head unit 50 side of the connection unit 70 and a second connecting part 73 for being connected with the cutter unit 60 is provided on a cutter unit 60 side of the connection unit 70. The first connecting part 72 and the second connecting part 73 can be connected with the head unit 50 and the cutter unit 60 by a magnetic force or the like. In a state that the first connecting part 72 and the head unit 50 are connected with each other, when the connection unit 70 is moved in the “Y”-axis direction, the head unit 50 is moved in the “Y”-axis direction. Further, in a state that the second connecting part 73 and the cutter unit 60 are connected with each other, when the connection unit 70 is moved in the “Y”-axis direction, the cutter unit 60 is moved in the “Y”-axis direction.

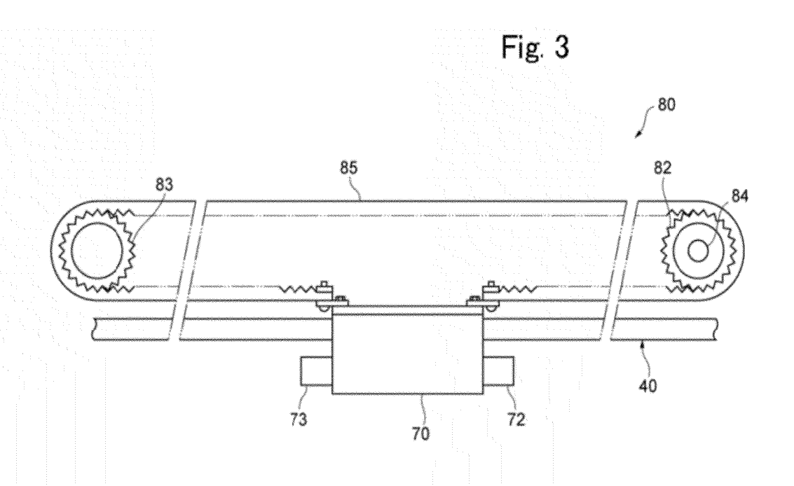

FIG. 3 is a view showing a structure of the drive mechanism. As shown in FIG. 3, the drive mechanism 80 moves the connection unit 70 in the “Y”-axis direction along the guide rail 40. The drive mechanism 80 is structured so as to include a drive pulley 82 and a driven pulley 83 which are provided at right and left end parts of the guide rail 40, a drive motor 84 (for example, a stepping motor or a servomotor) for rotationally driving the drive pulley 82, and a belt-shaped drive belt 85 which is stretched over the drive pulley 82 and the driven pulley 83. The connection unit 70 is fixed to the drive belt 85. Therefore, when the drive motor 84 is rotationally driven, the connection unit 70 is pulled by the drive belt 85 to be moved in the “Y”-axis direction along the guide rail 40.

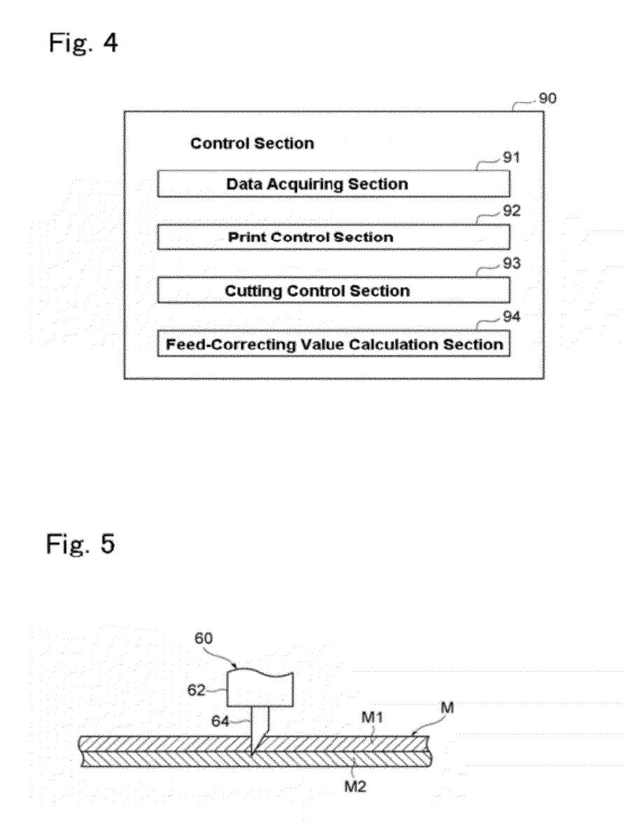

A control section 90 (not shown in FIG. 1) which integrally controls the printer cutter 1 is mounted in the printer cutter 1. The control section 90 is electrically connected with the feed rollers 20, the head unit 50, the cutter unit 60, the connection unit 70 and the drive motor 84. Therefore, the control section 90 controls the feed rollers 20, the head unit 50, the cutter unit 60, the connection unit 70 and the drive motor 84 to print an image on the medium “M” and to cut the medium “M” along a cut line. FIG. 4 is a diagram showing an example of a functional structure of the control section. As shown in FIG. 4, the control section 90 functions as a data acquiring section 91, a print control section 92, a cutting control section 93 and a feed-correcting value calculation section 94. In this embodiment, the control section 90 is mainly structured of a computer including a CPU, a ROM and a RAM and these functions are realized by reading predetermined computer software to the CPU and the RAM and by operating them under the control of the CPU.

The data acquiring section 91 acquires data transmitted from an external device such as a personal computer. The data transmitted from the external device includes cut data for cutting the medium “M” along a predetermined cut line, print data for printing an origin mark (register mark) indicating the origin and a predetermined image on the medium “M”, and a command correcting value which will be described below.

The print control section 92 integrally controls the feed rollers 20, the head unit 50, the connection unit 70, the drive motor 84 and the like on the basis of the print data which have been acquired by the data acquiring section 91 to print origin mark at a predetermined position of the medium “M” and to print the image in a printing region “a” of the medium “M” with the origin mark as a reference. Specifically, the print control section 92 moves the medium “M” in the “X”-axis direction by controlling the feed rollers 20. Further, the print control section 92 controls the head unit 50 to eject ink droplets of respective colors from the head unit 50. Further, the print control section 92 connects the connection unit 70 with the head unit 50 by controlling the connection unit 70 and the drive motor 84 to move the head unit 50 in the “Y”-axis direction. Therefore, when the print control section 92 moves the head unit 50 in the “Y”-axis direction to move the head unit 50 above the printing region “a” of the medium “M”, the print control section 92 makes ink droplets of the respective colors eject from the head unit 50 to print the image in the printing region “a” of the medium “M”.

The cutting control section 93 integrally controls the feed rollers 20, the cutter unit 60, the connection unit 70, the drive motor 84 and the like on the basis of the cut data which have been acquired by the data acquiring section 91 to cut the printing region “a” of the medium “M” along the cut line before an image is printed on the medium “M”. Specifically, the cutting control section 93 controls the feed rollers 20 to move the medium “M” in the “X”-axis direction. Further, the cutting control section 93 controls the cutter unit 60 to vertically move the cutter holder 62 in the “Z”-axis direction and to turn the cutter holder 62 around the “Z”-axis direction. In this embodiment, as shown in FIG. 5, a lowered position when the cutter holder 62 is lowered is adjusted so that a cutting edge (tip end) of the cutter member 64 penetrates through the sticker “M1” and slightly cuts the mount “M2”. Further, the cutting control section 93 connects the connection unit 70 with the cutter unit 60 by controlling the connection unit 70 and the drive motor 84 to move the cutter unit 60 in the “Y”-axis direction. Therefore, the cutting control section 93 moves the cutter unit 60 in the “Y”-axis direction and feeds the medium “M” in the “X”-axis direction and, when the cutter unit 60 is moved above the printing region “a” of the medium “M”, the cutting control section 93 vertically moves the cutter holder 62 in the “Z”-axis direction and turns the cutter holder 62 around the “Z”-axis direction to cut out the sticker “M1” of the medium “M”.

The feed-correcting value calculation section 94 calculates a feed correcting value “Δx” when the medium “M” is to be fed in the “X”-axis direction by the feed rollers 20.

The feed correcting value “Δx” will be described below. Generally, in the printer cutter 1, an image is printed through one or a plurality of passes. Therefore, banding may occur in which a gap space is occurred between the passes or the passes are overlapped with each other. Further, the banding is varied depending on a thickness and a type of the medium “M”. Therefore, when the print data and the cut data are transmitted from an external device to the printer cutter 1, a command correcting value “Δx” is also transmitted which is previously set depending on a thickness and a type of the medium “M” so as to uniform a print density between passes. In the printer cutter 1, the command correcting value “Δx” is reflected in a feeding amount of the medium “M” to feed the medium “M”.

However, in practice, a position of the medium “M” with respect to the feed rollers 20 may be displaced due to mechanical errors of the feed rollers 20 and a slip between the feed rollers 20 and the medium “M”. Further, in a case that printing and cutting are performed while an elongated medium “M” is wound, when a winding amount of the medium “M” is varied, tension acted on the medium “M” may be varied to cause a feeding amount of the medium “M” to vary. Therefore, a correcting value of a feeding amount of the medium “M” which is set in the printer cutter 1 for preventing the feeding displacement of the medium “M” is set as the feed correcting value “Δx”.

The feed-correcting value calculation section 94 prints two predetermined medium feed-correction adjusting patterns along the “X”-axis direction and the feed correcting value “Δx” is calculated so that a border portion of first and second medium feed-correction adjusting patterns “P” becomes uniform color density.

Further, the feed-correcting value calculation section 94 corrects the feeding amount of the medium “M” by the feed rollers 20 by using the calculated feed correcting value “Δx” and corrects coordinate values of the cut line which are indicated by the cutting control section 93.

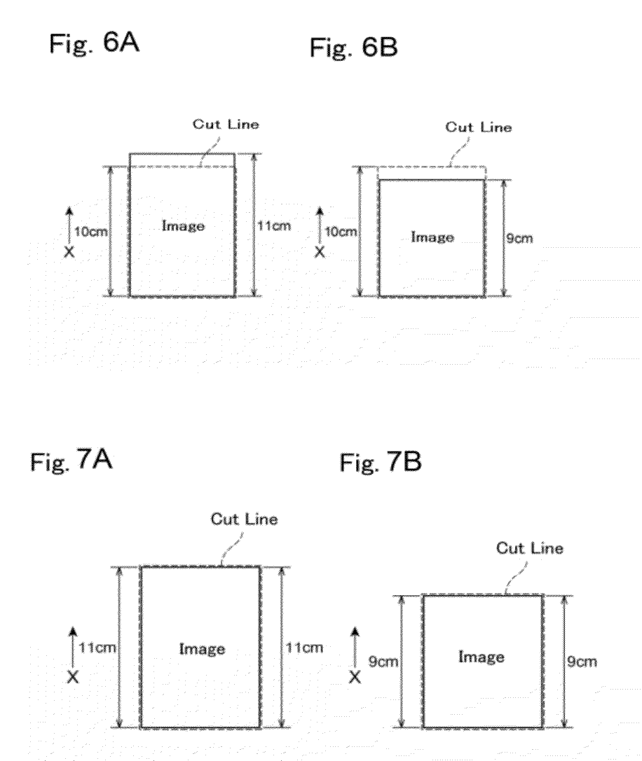

Correction of the cut line using the feed correcting value “Δx” will be described below with reference to FIGS. 6A and 6B and FIGS. 7A and 7B. FIGS. 6A and 6B and FIGS. 7A and 7B are views for explaining correction of the cut line. FIGS. 6A and 6B show cases where the feed correcting value “Δx” is not reflected in the cut line and FIGS. 7A and 7B show cases where the feed correcting value “Δx” is reflected in the cut line. In FIGS. 6A and 6B and FIGS. 7A and 7B, both of a length in the “X”-axis direction of an image to be printed on a medium “M” and a length in the “X”-axis direction of a cut line for cutting the medium “M” are 10 cm. In FIGS. 6A and 6B and FIGS. 7A and 7B, FIGS. 6A and 7A show a case that the feed correcting value “Δx” is positive (+) and a feeding amount of a medium “M” is increased by the feed correcting value “Δx”. Further, FIGS. 6B and 7B show a case that the feed correcting value “Δx” is negative (−) and a feeding amount of a medium “M” is decreased by the feed correcting value “Δx”.

As shown in FIGS. 6A and 6B, when the feed correcting value “Δx” is calculated, since a feeding amount of the medium “M” is increased or decreased, the image printed on the medium “M” is extended or shortened in the “X”-axis direction. In FIG. 6A, a length in the “X”-axis direction of the printed image is extended to 11 cm and, in FIG. 6B, a length in the “X”-axis direction of the printed image is shortened to 9 cm. However, a length in the “X”-axis direction of a cut line is not varied by increase or decrease of the feeding amount of the medium “M” and thus the cut line is displaced from the printed image which has been extended or shortened.

In order to prevent the problem, as shown in FIGS. 7A and 7B, the feed correcting value “Δx” is reflected in the coordinate values of the cut line, in other words, the coordinate values of the cut line are corrected by using the feed correcting value “ A x” and, as a result, the cut line can be coincided with the printed image which is extended or shortened. In FIG. 7A, the length in the “X”-axis direction of the cut line is corrected and extended to 11 cm and, in FIG. 7B, the length in the “X”-axis direction of the cut line is corrected and shortened to 9 cm.

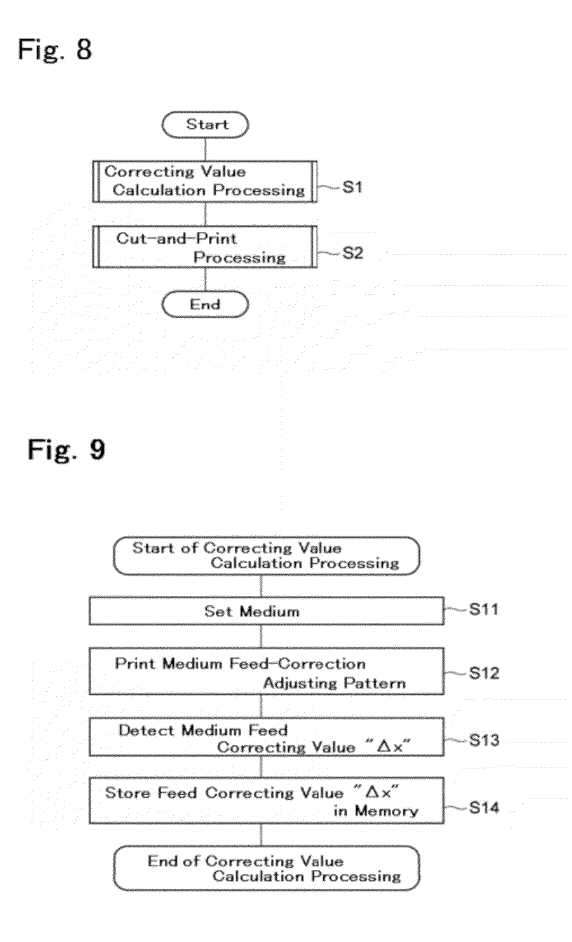

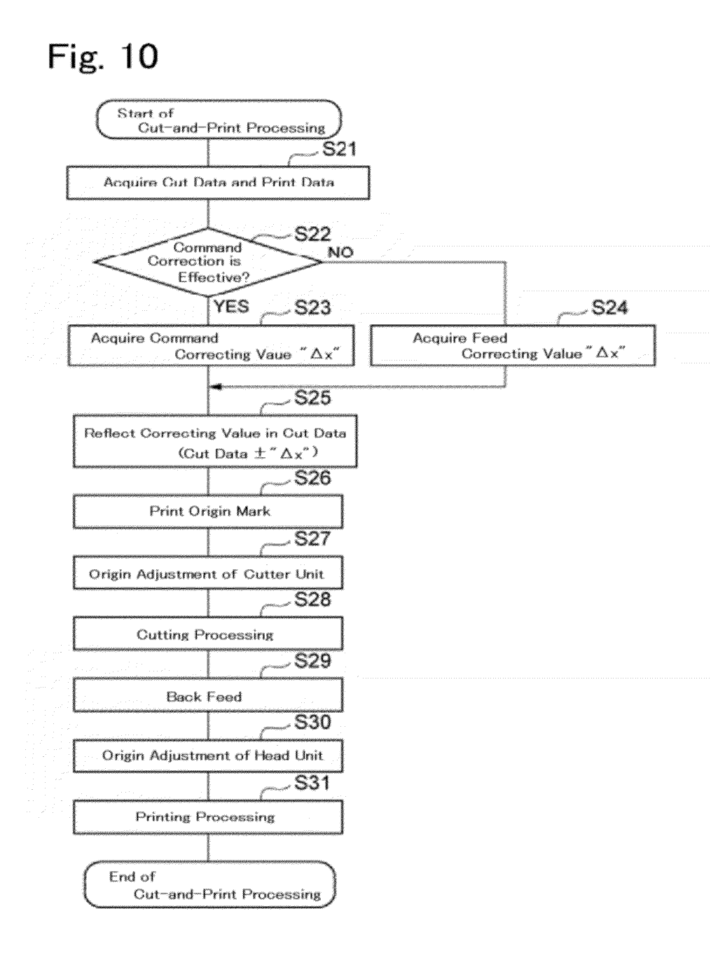

Next, an operation of the printer cutter 1 in accordance with the embodiment of the present embodiment will be described below with reference to FIGS. 8 through 10. FIG. 8 is a flow chart showing a processing operation of the printer cutter, FIG. 9 is a flow chart showing a correcting value calculation processing shown in FIG. 8, and FIG. 10 is a flow chart showing a cut-and-print processing shown in FIG. 8. The processing operation of the printer cutter 1 described below is performed in the control section 90 so that a processing section (not shown) structured of a CPU and the like integrally manages the functions such as the data acquiring section 91, the print control section 92, the cutting control section 93, the feed-correcting value calculation section 94 and the like according to a program recorded in a storage device such as a ROM as follows.

As shown in FIG. 8, the printer cutter 1 executes a correcting value calculation processing (step S1) and, after that, the printer cutter 1 executes a cut-and-print processing (step S2).

First, the correcting value calculation processing will be described below with reference to FIG. 9. As shown in FIG. 9, first, the printer cutter 1 drives the feed rollers 20 to feed a medium “M” in the “X”-axis direction and sets the medium “M” on the platen 30 (step S 11).

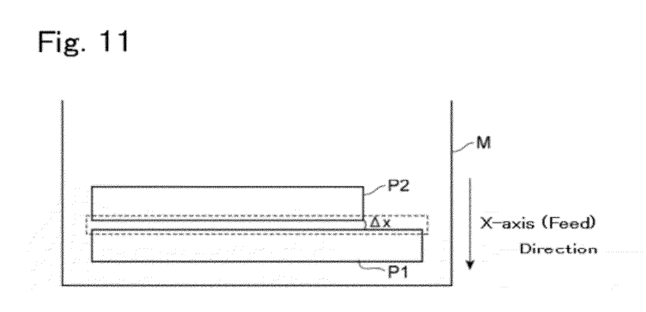

Next, the printer cutter 1 prints medium feed-correction adjusting patterns (step S12). FIG. 11 is a view for explaining calculation of a feed correcting value. As shown in FIG. 11, in the step S12, first, the head unit 50 is moved in the “Y”-axis direction and a predetermined medium feed-correction adjusting pattern “P1” is printed on the medium “M”. Next, after the medium “M” is fed by the feed rollers 20 by one pass in the “X”-axis direction, the head unit 50 is moved in the “Y”-axis direction again and a predetermined medium feed-correction adjusting pattern “P2” is printed on the medium “M”. In this manner, two medium feed-correction adjusting patterns are printed on the medium “M” along the “X”-axis direction.

Next, the printer cutter 1 calculates a medium feed correcting value “Δx” by using the first medium feed-correction adjusting pattern “P1” and the second medium feed-correction adjusting pattern “P2” which have been printed in the step S12 (step S13). As shown in FIG. 9, in the step S13, a density variation width is detected in which a printed density is varied at a boundary portion between the first medium feed-correction adjusting pattern “P1” and the second medium feed-correction adjusting pattern “P2”. The density variation width is detected by judging the color density at the boundary portion between the first medium feed-correction adjusting pattern “P1” and the second medium feed-correction adjusting pattern “P2”. This judgment may be performed by manually operated detection on the basis of visual inspection of a worker or by automatic detection by utilizing a photo sensor or the like. The feed-correcting value calculation section 94 sets the density variation width which has been detected as the feed correcting value “Δx” when the medium “M” is to be fed. In other words, the feed correcting value “Δx” is detected so that the boundary portion between the first medium feed-correction adjusting pattern “P1” and the second medium feed-correction adjusting pattern “P2” becomes uniform density.

Next, the printer cutter 1 stores the medium feed correcting value “Δx” which has been detected in the step S13 in a storage device (not shown) such as a memory (step S14).

Next, the cut-and-print processing will be described below with reference to FIG. 10. As shown in FIG. 10, data transmitted from an external device such as a personal computer are acquired (step S21). The data transmitted from the external device includes print data for printing an origin mark on the medium “M”, the command correcting value “Δx”, cut data for cutting the medium “M” along a cut line, and print data for printing an image on the medium “M”. When a large amount of data is to be transmitted from the external device in the step S2, the following processing is performed simultaneously in parallel while acquiring the data.

Next, the printer cutter 1 determines whether the command correction is effective or not (step S22). In other words, in the step S22, it is judged whether the command correcting value “Δx” acquired in the step S21 is used for correction of the coordinate values of the cut line indicated by the cut data acquired in the step S21, or the feed correcting value “Δx” stored in the step S14 of the correcting value calculation processing (step S1) is used. The determination in the step S22 is executed, for example, on the basis of the initial setting of the printer cutter 1, on the basis of setting through an operation by a user, or information included in the print data or the cut data or the like.

When it is determined that the coordinate values of the cut line are to be corrected by using the command correcting value “Δx” (step S22: YES), the printer cutter 1 acquires the command correcting value “Δx” which has been acquired in the step S21 (step S23).

On the other hand, when it is determined that the coordinate values of the cut line are to be corrected by using the feed correcting value “Δx” (step S22: NO), the printer cutter 1 acquires the feed correcting value “Δx” which has been stored in the step S14 (step S24).

Next, the printer cutter 1 reflects the command correcting value “Δx” acquired in the step S23 or the feed correcting value “Δx” acquired in the step S24 in the cut data acquired in the step S21 (step S25). In other words, in the step S25, the coordinate values of the cut line indicated by the cut data are corrected by using the command correcting value “Δx” or the feed correcting value “Δx”.

Next, the printer cutter 1 prints an origin mark on the medium “M” on the basis of the print data of the origin mark acquired in the step S21 (step S26).

Next, the printer cutter 1 performs origin adjustment of the medium “M” with respect to the cutter unit 60 with the origin mark printed in the step S26 as a reference (step S27). In the step S27, origin adjustment of the medium “M” with respect to the cutter unit 60 is performed by detecting the origin mark by using a photo sensor (not shown) or the like which is mounted on the cutter unit 60 or the guide rail 40. In this embodiment, in a case that a distance is short which is required to feed the medium “M” by the feed rollers 20 after the origin mark is printed in the step S26 and until a cutting processing is performed as described below in the step S28, positional displacement of the medium “M” with respect to the feed rollers 20 is hardly occurred. When the origin adjustment in the step S26 is not required as described above, the step S26 may be omitted.

Next, the printer cutter 1 performs a cutting processing (step S28). In other words, in the step S28, the medium “M” is cut along the cut line having been corrected in the step S25 to perform a cut-out processing of the sticker “M1” before an image is printed on the medium “M”. In the cutting processing, first, the connection unit 70 is moved to the right side in the “Y”-axis direction and the head unit 50 is returned to the standby position. In a case that the head unit 50 has been already located at the standby position, a processing for returning the head unit 50 to the standby position is omitted. Next, the connection unit 70 is moved to the left side in the “Y”-axis direction to connect the second connecting part 73 with the cutter unit 60. After that, based on the cut data acquired in the step S1, while the cutter unit 60 is moved in the “Y”-axis direction and the medium “M” is moved in the “X”-axis direction with the origin specified in the step S2 as a reference, the cutter holder 62 is vertically moved in the “Z”-axis direction and is turned around the “Z”-axis direction. When the printing region “a” of the medium “M” is cut along a predetermined line as described above, a cut-out work in which the sticker “M1” is cut out in a predetermined shape is performed.

Next, the printer cutter 1 back-feeds the medium “M” to return to the origin (step S29). In other words, in the step S29, the feed rollers 20 are driven to feed the medium “M” in the opposite direction to the “X”-axis direction so that the head unit 50 is located at the same position as the origin mark printed in the step S26 in the “X”-axis direction.

Next, the printer cutter 1 performs the origin adjustment of the medium “M” with respect to the head unit 50 with the origin mark printed in the step S26 as a reference (step S30). In the step S30, origin adjustment of the medium “M” with respect to the head unit 50 is performed by detecting the origin mark by using a photo sensor (not shown) or the like which is mounted on the head unit 50 or the guide rail 40.

Next, the printer cutter 1 performs a printing processing (step S31). In other words, in the step S31, after a cutting processing has been performed, an image is printed in the printing region “a” of the medium “M” on the basis of the print data acquired in the step S1. In the printing processing, first, the connection unit 70 is moved to the left side in the “Y”-axis direction to return the cutter unit 60 to the standby position and the connection of the second connecting part 73 with the cutter unit 60 is released. Next, the connection unit 70 is moved to the right side in the “Y”-axis direction and the first connecting part 72 is connected with the head unit 50. Further, in a case that the medium “M” has been moved in the “X”-axis direction in the step S4, the medium “M” is back-fed on the basis of the origin specified in the step S2. Next, based on the print data acquired in the step S1, while the head unit 50 is moved in the “Y”-axis direction with the origin specified in the step S2 as a reference, ink droplets of respective colors are ejected from the head unit 50. In this manner, the image is printed in the printing region “a” of the medium “M”. When all images have not been printed, the medium “M” is fed in the “X”-axis direction and the above-mentioned processing is repeated and, as a result, all images are printed.

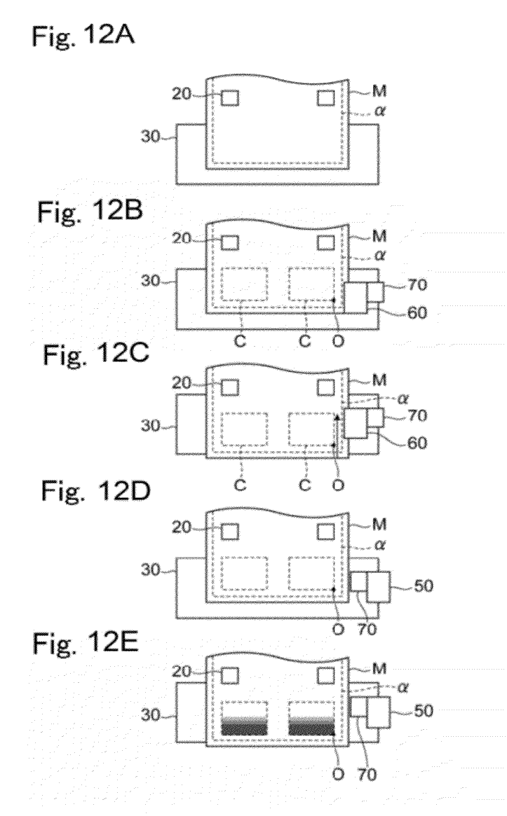

Next, an operation of the above-mentioned printer cutter 1 will be described below with reference to FIGS. 12A through 12E. FIGS. 12A through 12E are schematic views showing an operation of the printer cutter. FIG. 12A shows a state that a medium “M” is set on the platen, FIG. 12B shows a state that an origin mark has been printed and just before the medium “M” is cut, FIG. 12C shows a state after the medium “M” has been cut, FIG. 12D shows a state just before images are printed on the medium “M”, and FIG. 12E shows a halfway state of printing images on the medium “M”. In FIGS. 12A through 12E, “O” indicates the origin of the medium “M” as a reference for printing and cutting and “C” indicates cut lines along which the medium “M” is cut on the basis of cut data.

As shown in FIG. 12A, first, the medium “M” is fed in the “X”-axis direction and is set on the platen.

Next, as shown in FIG. 12B, an origin mark is printed at the origin “O” of the medium “M”.

Next, the medium “M” is cut along a cut line “C” with the origin mark as a reference.

When cutting of the medium “M” is finished, as shown in FIG. 12C, the medium “M” has been moved in the “X”-axis direction and thus, as shown in FIG. 12D, the medium “M” is back-fed and is returned to the origin “O”.

After that, as shown in FIG. 12E, images are printed in a printing region “a” of the medium “M” with the origin mark as a reference.

As described above, according to this embodiment, when a printing region “a” of the medium “M” is to be cut, the cutter unit 60 is moved in the “Y”-axis direction with respect to the medium “M” but printing of an image is performed after the printing region “a” of the medium “M” has been cut. Therefore, inks having been printed on the printing region “a” of the medium “M” are not rubbed by the cutter unit 60 and thus the printed image is not blurred. Accordingly, since printing is performed after the medium “M” has been cut, a heating means for drying inks in order to cut the medium “M” is not required. Further, since a time period for drying the inks can be reduced, a processing speed is enhanced. In addition, the medium “M” has been cut before an image is printed and thus, even when the medium “M” is curled due to printing of the image, the medium “M” is cut satisfactorily.

Further, since the origin mark is printed before cutting of the medium “M” is performed by the cutting control section 93, origin adjustment of the medium “M” with respect to the cutter unit 60 and origin adjustment of the medium “M” with respect to the head unit 50 can be performed and thus displacement of printing position from the cutting position is corrected.

When cutting of the medium “M” has been performed by the cutting control section 93, the medium “M” is back-fed and the origin adjustment is performed on the basis of the origin mark. Therefore, displacement of the medium with respect to the feed rollers 20 which is occurred at the time of cutting of the medium “M” and back-feeding of the medium “M” is corrected. In this manner, displacement of the printing position from the cutting position is corrected effectively.

In addition, when a medium is fed, feeding displacement of the medium may occur due to mechanical errors or a slip of the medium. However, a feed correcting value “Δx” is calculated by the feed-correcting value calculation section 94 and a feeding amount of the medium “M” is corrected by the calculated feed correcting value “Δx” and thus the feeding displacement of the medium “M” is restrained. Therefore, banding can be restrained which occurs in the printed image having been printed on the medium “M” by the print control section 92.

In addition, the cutting control section 93 reflects the feed correcting value “Δx” in the cut data to cut the medium and thus, extending amounts or shortening amounts of the image and the cut line are coincided with each other. Therefore, displacement of the image from the cut line is restrained.

Although the present invention has been shown and described with reference to the embodiment, the present invention is not limited to the above-mentioned embodiment. For example, in the embodiment described above, a medium “M” is moved in the “X”-axis direction by the feed rollers 20. However, for example, a medium “M” may be fixed in a state that the medium “M” is placed on a flat bed and the head unit 50 and the cutter unit 60 are moved in the “X”-axis direction so that the medium “M” and the head unit 50 and the cutter unit 60 are relatively moved in the “X”-axis direction.

Further, in the embodiment described above, a cutting processing is performed in which a cutting edge (tip end) of the cutter member 64 is penetrated through the sticker “M1” to slightly cut the mount “M2”. However, a cutting depth of the medium “M” may be set in any depth. For example, only the surface of the medium “M” may be thinly cut or the medium “M” may be cut completely.

Further, the cut line “C” for cutting a medium in the cutting processing may be set in any shape, for example, a straight line shape, a curved shape, a broken line shape (perforations) or the like.

Further, in the embodiment described above, a medium “M” is cut in only the printing region “a” in the printing processing but an outer side of the printing region “a” may be cut.

Further, in the embodiment described above, the head unit 50, the cutter unit 60, the connection unit 70 and the drive mechanism 80 are separately structured from each other but a part of these parts or the entire parts may be structured integrally.

Further, in the embodiment described above, a normal cutter member 64 is used. However, a cutter member may be used which is provided with an eccentric cutter in which a cutting edge of the cutter member 64 is eccentric with respect to a rotation center axis of the cutter holder 62. In this case, when the cutter member provided with the eccentric cutter is turnably held with respect to the cutter holder, the cutter member is turned so that the cutting edge of the cutter member 64 is directed to a moving direction of the cutter holder 62 with respect to the medium “M”. Therefore, control for turning the cutter member 64 can be reduced.

Further, in the embodiment described above, the head unit 50, the cutter unit 60 and the connection unit 70 are separately structured from each other. However, the head unit 50 and the connection unit 70 may be integrally structured with each other, the cutter unit 60 and the connection unit 70 may be integrally structured with each other, and the head unit 50 and the cutter unit 60 and the connection unit 70 may be integrally structured with each other.

Further, in the embodiment described above, a heating means for drying inks is not provided but a heating means (for example, heater) may be provided. In this case, inks ejected to a medium “M” are dried quickly.

A printer cutter in accordance with the embodiment of the present invention includes a head unit which is relatively moved with respect to a medium and prints an image on the medium, a cutter unit which is relatively moved with respect to the medium and cuts the medium, a cutting control means for cutting a printing region of the medium on which the image is to be printed by using the cutter unit before the image is printed in the printing region, and a print control means for printing the image in the printing region by using the head unit after cutting of the printing region has been performed.

According to the printer cutter in accordance with the embodiment of the present invention, when a printing region of a medium is to be cut, the cutter unit is relatively moved with respect to the medium but printing of an image is performed after the printing region has been cut. Therefore, inks having been printed on the printing region are not rubbed by the cutter unit and thus the printed image is not blurred. Accordingly, since printing is performed after the medium has been cut, a heating means for drying inks in order to cut the medium is not required. Further, since a time period for drying inks can be reduced, the processing speed is enhanced. In addition, the medium is cut before an image is printed and thus, even when the medium is curled due to printing of the image, the medium is cut satisfactorily.

It is preferable that the print control means prints an origin mark indicating origin on the medium before cutting is performed by the cutting control means. As described above, when the origin mark is printed before cutting is performed by the cutting control means, origin adjustment of a cutting position by the cutting control means, origin adjustment of a printing position by the print control means and the like can be performed and thus displacement of the printing position from the cutting position can be corrected.

In this case, it is further preferable that the print control means back-feeds the medium to perform origin adjustment on the basis of the origin mark after cutting has been performed by the cutting control means. After cutting is performed by the cutting control means, the medium is returned to the origin by back-feeding the medium. However, the medium may be displaced when the medium is cut by the cutting control means or when the medium is back-fed. Therefore, when cutting has been performed by the cutting control means, the medium is back-fed and origin adjustment is performed on the basis of the origin mark. As a result, the displacement of the medium is corrected and thus the displacement of the printing position with respect to the cutting position is corrected effectively.

Further, it is preferable that the printer cutter further includes a feed-correcting value calculation means which calculates a feed correcting value for correcting a feeding amount of the medium and the cutting control means cuts the medium by reflecting the feed correcting value calculated by the correcting value calculating means.

When the medium is fed, feeding displacement of the medium may occur due to mechanical errors or a slip of the medium. However, a feed correcting value is calculated by the feed correcting value calculation means and a feeding amount of the medium is corrected by the calculated feed correcting value and thus the feeding displacement of the medium is restrained. Therefore, banding can be restrained which occurs in the printed image printed on the medium by the print control means. On the other hand, in a case that a feeding amount of the medium is corrected by the feed correcting value, an image printed on the medium by the print control means is extended or shortened but a cut line which is cut by the cutting control means is not extended or shortened and, as a result, displacement may occur between the image and the cut line. Therefore, in the embodiment of the present invention, the cutting control means cuts the medium by reflecting the feed correcting value and thus extending amounts or shortening amounts of the image and the cut line are coincided with each other and, as a result, displacement of the image from the cut line is restrained.

A control method for a printer cutter in accordance with the embodiment of the present invention having a head unit which is relatively moved with respect to a medium and prints an image on the medium and a cutter unit which is relatively moved with respect to the medium and cuts the medium includes a cutting control step in which a printing region of the medium on which the image is to be printed is cut by using the cutter unit before the image is printed in the printing region, and a print control step in which the image is printed in the printing region by using the head unit after cutting of the printing region has been performed.

According to the control method for the printer cutter in accordance with the embodiment of the present invention, when a printing region of a medium is to be cut, the cutter unit is relatively moved with respect to the medium but printing of an image is performed after the printing region has been cut. Therefore, inks having been printed in the printing region are not rubbed by the cutter unit and thus the printed image is not blurred. Accordingly, a time period which is conventionally required for drying inks in order to cut the medium after the image has been printed is not required and thus the processing speed can be enhanced. In addition, the medium is cut before an image is printed and thus, even when the medium is curled due to printing of the image, the medium is cut satisfactorily.

According to the embodiment of the present invention, the processing speed can be enhanced without blurring the printed image.

Obviously, numerous modifications and variations of the present invention are possible in light of the above teachings. It is therefore to be understood that within the scope of the appended claims, the invention may be practiced otherwise than as specifically described herein.

What is claimed is:

1. A printer cutter comprising:
a head device to print an image on a medium, the head device being relatively movable with respect to the medium;
a cutter device to cut the medium, the cutter device being relatively movable with respect to the medium;
a cutting controller configured to cut a printing region of the medium on which the image is to be printed by using the cutter device before the image is printed in the printing region; and
a print controller configured to print the image in the printing region by using the head device after the printing region has been cut by the cutting controller.

2. The printer cutter according to claim 1, wherein
the print controller prints an origin mark indicating origin on the medium by using the head device before the printing region has been cut by the cutting controller.

3. The printer cutter according to claim 2, further comprising:
a feeder to feed the medium,
wherein the print controller back-feeds the medium to perform origin adjustment on a basis of the origin mark by using the feeder after the printing region has been cut by the cutting controller.

4. The printer cutter according to claim 3, further comprising:
a feed-correcting value calculator configured to calculate a feed correcting value to correct a feeding amount of the medium,
wherein the cutting controller cuts the medium based on the feed correction value calculated by the correcting value calculator.

5. The printer cutter according to claim 1, further comprising:
a feed-correcting value calculator configured to calculate a feed correcting value to correct a feeding amount of the medium,
wherein the cutting controller cuts the medium based on the feed correction value calculated by the correcting value calculator.

6. The printer cutter according to claim 2, further comprising:
a feed-correcting value calculator configured to calculate a feed correcting value to correct a feeding amount of the medium,
wherein the cutting controller cuts the medium based on the feed correction value calculated by the correcting value calculator.

7. A method for controlling a printer cutter, comprising:
cutting a printing region of a medium on which an image is to be printed using a cutter device of the printer cutter before the image is printed in the printing region; and
printing the image in the printing region using a head device of the printer cutter after the printing region has been cut.

8. The method according to claim 7, further comprising:
printing an origin mark indicating origin on the medium by using the head device before the printing region has been cut.

9. The method according to claim 8, further comprising:
back-feeding the medium to perform origin adjustment on a basis of the origin mark after the printing region has been cut.

10. The method according to claim 9, further comprising:
calculating a feed correcting value to correct a feeding amount of the medium,
wherein the cutting of the medium is performed based on the feed correction value.

11. The method according to claim 7, further comprising:
calculating a feed correcting value to correct a feeding amount of the medium,
wherein the cutting of the medium is performed based on the feed correction value.

12. The method according to claim 8, further comprising:
calculating a feed correcting value to correct a feeding amount of the medium,
wherein the cutting of the medium is performed based on the feed correction value.
